(19) United States
(12) Patent Application Publication
(10) Pub. No.: US 2009/0296701 A1
(43) Pub. Date: Dec. 3, 2009

(54) METHOD AND APPARATUS FOR IMPROVING CHANNEL ACQUISITION

(75) Inventors: Aner Gusic, Linkoping (SE); Henrik Salomonsson, Norrkoping (SE); Peter Zander, Linkoping (SE)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 12/129,723

(22) Filed: May 30, 2008

(51) Int. Cl. H04L 12/28

(52) U.S. Cl. 370/389

(57) ABSTRACT

A method and apparatus for improving channel acquisition times are disclosed. For example, the method includes receiving at a router a data stream destined to one or more subscribers. Then, the method generates at said router at least one new access point in between two access points of said data stream. The method concludes by forwarding said at least one new access point upon detecting a request from a subscriber for receiving said data stream.

### FIELD OF THE INVENTION

The present invention generally relates to the improvement of channel acquisition and, in particular, generating a random access point to improve channel acquisition time.

### BACKGROUND

Currently, subscribers to multimedia content may experience long delays when changing channels. For example, a subscriber may see a black screen when attempting to change channels. Most programs are now provided to a subscriber's device, e.g., a set top terminal in compressed form, for example MPEG encoding. When a subscriber requests to change the channel on the subscriber's set top terminal, the set top terminal must wait for a reference frame or access point, e.g., an “I” frame, before it can start decoding the image. Since the reference frame is generally very large in terms of the number of bits, the reference frames may be spaced apart between a large number of frames, e.g., “B” or “P” frames. As a result, the black screen that a subscriber may see while waiting for the set top terminal to acquire the new channel is due to the process of waiting for the next reference frame.

### BRIEF DESCRIPTION OF THE DRAWINGS

The teaching of the present invention can be readily understood by considering the following detailed description in conjunction with the accompanying drawings, in which:

FIG. 1 illustrates a high level block diagram of an illustrative network architecture in accordance with an embodiment of the present invention;

FIG. 2 illustrates an illustrative flow diagram depicting a method for retrieving a media file from a remote device in accordance with an embodiment of the present invention;

FIG. 3 illustrates an illustrative timeline in accordance with an embodiment of the present invention; and

FIG. 4 illustrates a high level block diagram of an illustrative general purpose computer suitable for use in performing the functions described herein in accordance with an embodiment of the present invention.

To facilitate understanding, identical reference numerals have been used, where possible, to designate identical elements that are common to the figures.

### DETAILED DESCRIPTION

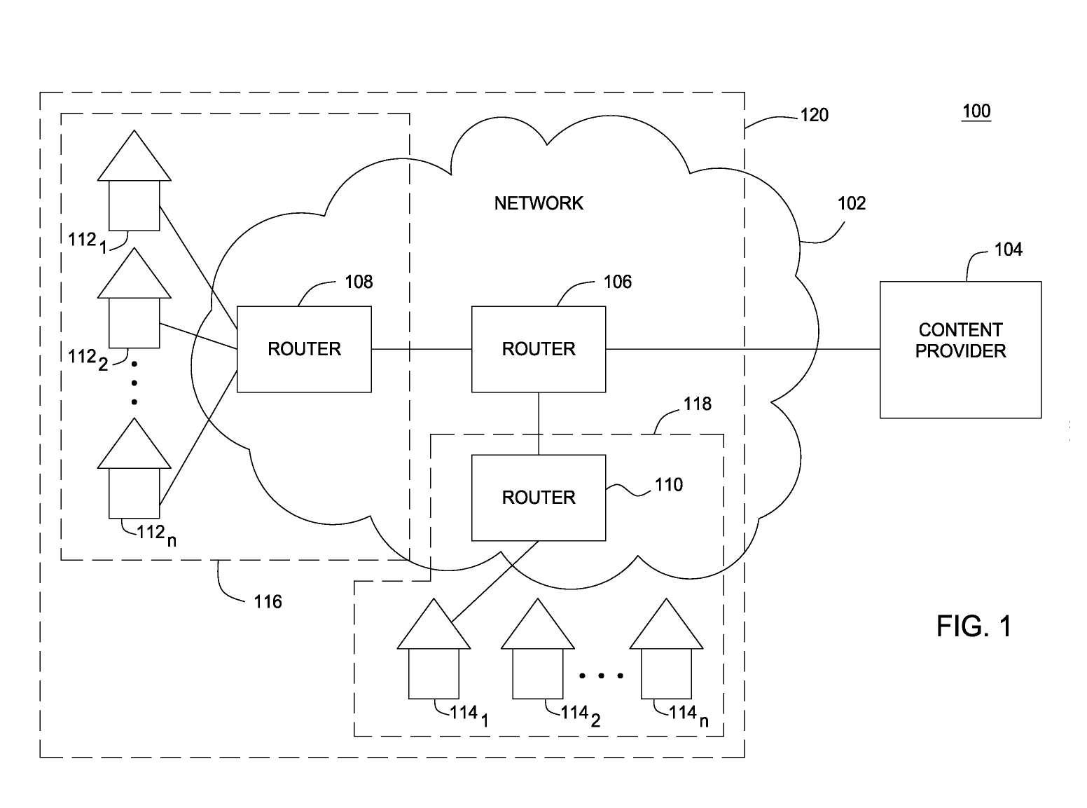

FIG. 1 illustrates a high level block diagram of an illustrative network architecture 100 in accordance with an embodiment of the present invention. In one embodiment, network architecture 100 includes a network 102, a content provider 104, a plurality of routers 106, 108 and 110 and a plurality of subscribers 112₁, 112₂ to 112ₙ (also referred to herein collectively as subscribers or subscriber 112) and 114₁, 114₂ to 114ₙ (also referred to herein collectively as subscribers or subscriber 114). The content provider 104 may be a cable services provider having a server or a cable head end (not shown). It should be noted that any number of routers can be implemented in the network 102. Furthermore, various network elements are not illustrated in FIG. 1 to simplify the discussion of the present invention.

The content provider 104 delivers programming to the subscribers via data streams. The data streams are transported through various levels and path combinations of routers 106, 108 and 110 to the subscribers 112 and 114.

In one embodiment, the routers 106, 108 and 110 may be organized in a hierarchy architecture having multiple levels of routers. For example, some routers 108 and 110 are deemed to be local routers or edge routers and some routers 106 are deemed to be regional routers or core routers. In other words, the routers 108 and 110 would be on a first level and the router 106 would be on a second level. Additional levels of routers may exist above router 106 and so on.

FIG. 1 illustrates this concept via dashed lines 116, 118 and 120. Dashed lines 116 may represent a first level of routers at a local service area for router 108 that serves subscribers 112. A similar dashed line 118 may be drawn around a local service area for router 110 that serves subscribers 114. Dashed lines 120 may represent a second level of routers at a regional service area that include router 106 that serves subscribers 112 and subscribers 114. For example, the second level represented by the dashed lines 120 includes all the local service area routers at the first level represented by dashed lines 116 and 118. It should be noted that although only three routers are illustrated, there may be any number of routers in each level of routers and multiple levels of routers up to a core router.

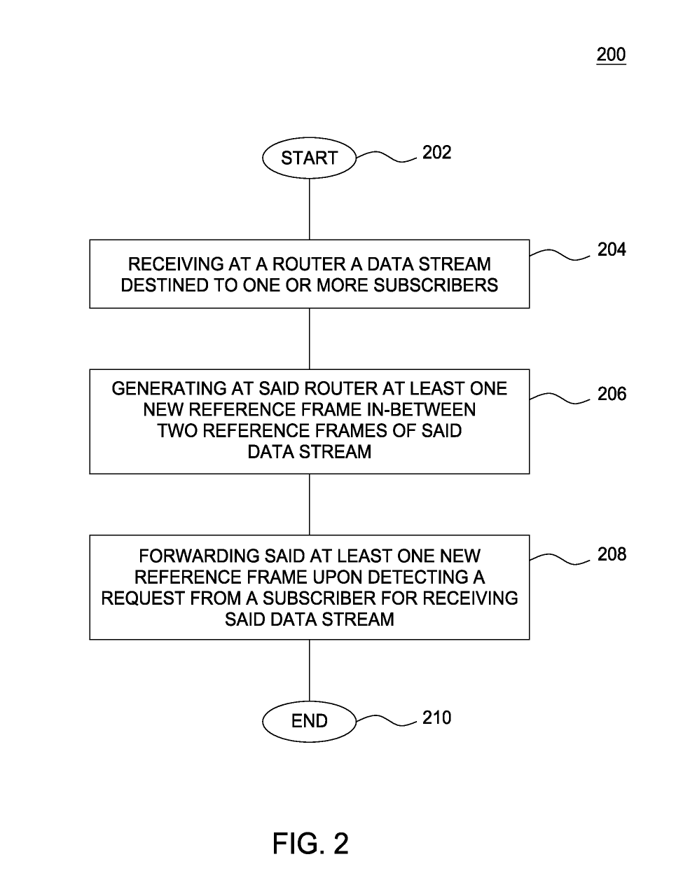

FIG. 2 depicts an illustrative flow diagram depicting a method 200 for improving channel acquisition times. In one embodiment, the method is executed in any one of the routers 106,108 or 110. The method 200 starts at step 202.

At step 204, the method 200 receives at a router 106,108 or 110 a data stream destined to one or more subscribers 112 and 114. Referring to router 108 serving subscribers 112 as an example, a first subscriber 112₁ may be watching a program on channel 2. A second subscriber 112₂ may be watching a program on channel 3. Thus, the router 108 receives data streams for channels 2 and 3 that are destined for subscribers 112₁ and 112₂, respectively.

The router 108 also includes a computer readable storage medium such as for example, a cache, hard drive or memory, to temporarily store the data streams, as necessary. In one embodiment, the computer readable storage medium may receive and temporarily store the data streams including the last received reference frame and all data up to the next reference frame. In another embodiment, the computer readable medium may temporarily store all decompressed versions of the data streams received by the router 108.

At step 206, the method 200 generates at least one new reference frame in between two reference frames of the data stream. In an embodiment, the programming carried by the data streams is compressed, for example, using motion compensation compression such as Moving Picture Experts Group (MPEG) encoding. MPEG encoding generates a reference frame or access point known as an “I” frame. In addition MPEG encoding generates “B” frames and “P” frames that require an “I” frame before they can be decoded. By contrast, “I” reference frames may be independently decoded.

More generally, in an embodiment, step 206 generates at least one new access point between two access points of the data stream. An access point can be either a reference frame or a random access point (RAP). That is, as used herein, the term “access point” is used generically and interchangeably to mean either a reference frame or a RAP, such usage being consistent with the encoding used in an embodiment. For example, in MPEG encoding, the access points may be referred to as reference frames, and in H.264 encoding, the access points may be referred to as RAPs. While the illustrative example below discusses reference frames, the method 200 applies generally to access points and RAPs.

To optimize bandwidth, a content provider 104 may encode programming in the data streams such that there are only a few reference frames. However, the fewer the reference frames, the longer a subscriber may be required to wait when the subscriber changes channels at his set top terminal. Namely, the set top terminal must acquire the next available “I” frame in the new channel before any video frame can be displayed. Thus, optimal encoding may result in poor channel acquisition time performance.

Continuing with the above example using router 108, in one embodiment the router 108 may include an encoder that may be able to generate new reference frames or access points. The new reference frames may be generated at pre-defined intervals. For example, if there are ten frames in a group of pictures (GOP) (i.e. ten frames in between each reference frame of an encoded data stream), then the router 108 may generate a new reference frame every five frames. It should be noted, however, that the router 108 may generate new reference intervals in any interval, for example every three frames, every twenty frames and the like.

In an alternate embodiment, the encoder may be able to generate new reference frames “on the fly” or on demand. For example, the router 108 may decompress the data stream for channel 2 as it is received and store the decompressed data stream in the computer readable medium while the data stream is being forwarded to the subscriber 112₁. When a subscriber 112₂ requests a channel change from channel 3 to channel 2, then at that point the encoder in router 108 may generate a new reference frame by encoding the uncompressed data stream at the point in time when the subscriber 112₂ requests the channel 2.

At step 208, the method 200 forwards the at least one new reference frame upon detecting a request from a subscriber for receiving the data stream. For example, the subscriber request for receiving the data stream may be created by a subscriber changing channels on his set top terminal.

Again, using the above example, subscriber 112₁ may be watching channel 2. Subscriber 112₂ may be watching channel 3. Consequently, data streams carrying channel 2 and channel 3 are received by the router 108. It should be noted that router 108 may receive as many streams as necessary to service subscribers 112. Two channels are described for simplicity in discussing the present invention.

The router 108 may temporarily store the data streams in a computer readable storage medium, as described above. At some later time, subscriber 112₂ may decide to watch channel 2 instead of channel 3. Upon detecting the subscriber's request for receiving the data stream carrying channel 3, the router 108 may forward the at least one newly generated reference frame to subscriber 112₂. As discussed above, the new reference frame may be generated at pre-defined intervals or the new reference frame may be generated “on the fly” or on demand upon detecting the subscriber's request for receiving the data stream.

In another embodiment, the method 200 may forward the last stored reference frame immediately to the subscriber upon detecting the subscriber's request for receiving the data stream. Subsequently, the method 200 then forwards the at least one newly generated reference frame to the subscriber. As a result, rather than seeing a black screen, the subscriber may see a still image on a display for a brief moment until the newly generated reference frame and all subsequent frames are forwarded to the subscriber. The method 200 concludes at step 210.

Although the method 200 was illustrated by example of router 108 and subscribers 112, it should be noted that the method may be executed by any router located at any level within the network 102 including, but not limited to, one or more of the routers 106, 108 or 110. For example, to service more subscribers and reduce costs, the method 200 may be executed by the router 106. In one embodiment, by implementing the method 200 on the second level or regional router 106, a balance between cost and efficiency may be achieved. The router 106 may generate the new reference frame and forward the generated reference frame to the appropriate first level router 108 or 110. As a result, the routers 108 and 110 may remain as “normal routers” and only router 106 need to be modified with the processing capability to execute method 200.

As illustrated by method 200 above, aspects of the present invention provide improved channel acquisition because a router may generate and insert reference frames into a data stream. Consequently, an embodiment of the present invention reduces the amount of time it takes for video to appear to a user when a user changes channels.

In addition, aspects of the present invention can advantageously allow the content provider 104 to maximize the encoding of the programming carried by the data streams. In other words, the content provider may optimize the encoding of the data streams by having minimal reference frames. In another aspect, an embodiment of the present invention can minimize the complexity required of the set top terminals in the subscriber's home.

It should be noted that although not specified, one or more steps of method 200 may include a storing, displaying and/or outputting step as required for a particular application. In other words, any data, records, fields, and/or intermediate results discussed in the method can be stored, displayed and/or outputted to another device as required for a particular application. Furthermore, steps or blocks in FIG. 2 that recites a determining operation or involve a decision do not necessarily require that both branches of the determining operation be practiced. In other words, one of the branches of the determining operation can be deemed as an optional step.

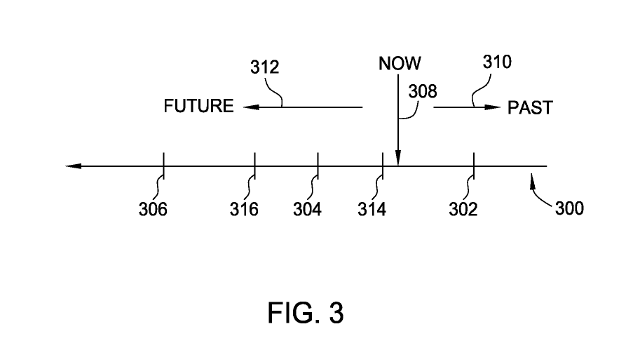

FIG. 3 provides an illustrative timeline 300 correlating to the timing of method 200. The timeline 300 includes access points 302, 304 and 306. An access point can be either a reference frame or a random access point (RAP). For example, in an embodiment using MPEG encoding, the access points 302, 304 and 306 may be referred to as reference frames, and in an embodiment using H.264 encoding, the access points 302, 304 and 306 may be referred to as RAPs. Although only three access points (i.e., reference frames or RAPs) are illustrated, it should be noted that there may be as many access points as are carried in a data stream encoded by the content provider 104.

An access point (e.g., access points 302, 304 and 306) may be further described as a start point; that is, a point in a live stream where decoding can start. On branching points in a network (e.g., routers 106,108 and 110), information about the type of data that is transferred within standard protocols is usually unknown. In other words, traditional routers are only tasked with the proper routing of the data (e.g., embodied in packets), but are not designed to actually understand or to process the content of the packets that are being routed by the routers. However, if the branching points in the network (e.g., routers 106, 108 and 110) are designed with the capability to actually process the packets that are being routed, (e.g., the routers are equipped with coders/decoders for one or more of various coding protocols), then the branching points can generate “start points” to assist in channel change requests. In one embodiment, the channel change latency time (known as zap time) can be reduced up to the longest time between two start points. For example, the zap time may be a few hundred milliseconds (ms) (e.g., approximately 100 ms to 500 ms) for MPEG and H.264.

Arrow 310 indicates a direction in the past along timeline 300 and arrow 312 indicates a direction in the future along timeline 300. As described in step 204, when a data stream is received, the router 106, 108 or 110 may store the data in between each reference frame or RAP (e.g., between access points 302 and 304, between access points 304 and 306, and so on).

Previously, when a subscriber request for receiving the data stream was detected (indicated by line 308), all data between line 308 and the next access point 304 would be discarded since all the data between line 308 and access point 302 was unavailable. This causes a visible delay to the subscriber. As discussed above and illustrated by timeline 300 in accordance with various embodiments of the present invention, the above scenario is resolved.

In accordance with one embodiment of the present invention, timeline 300 illustrates access points 314 and 316 newly generated at pre-determined intervals. When a subscriber request for receiving the data stream is detected (indicated by line 308), the router 106, 108 or 110 may forward the closest new access point 314.

In an alternate embodiment described above, when a subscriber request for receiving the data stream is detected (indicated by line 308), the router 106, 108 or 110 may generate a new reference frame “on the fly” or on demand and forward the newly generated reference frame to the subscriber.

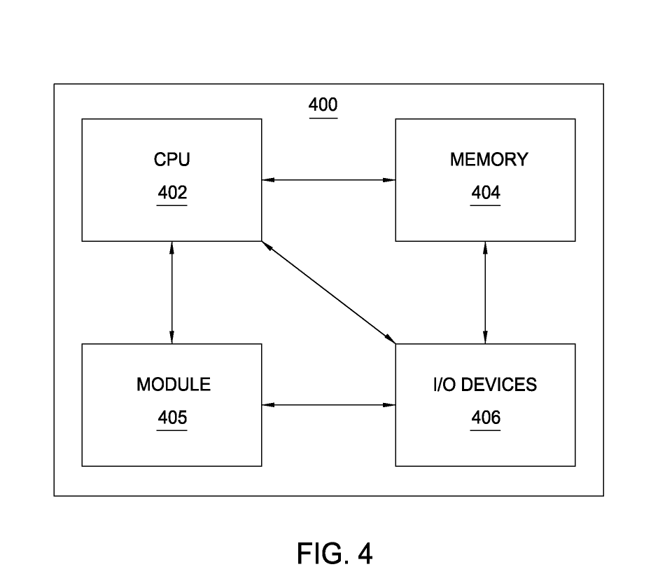

FIG. 4 illustrates a high level block diagram of an illustrative general purpose computer suitable for use in performing the functions described herein. The general purpose computer 400 may be a part of the routers 106, 108 or 110. As depicted in FIG. 4, the general purpose computer 400 comprises a processor element 402 (e.g., a CPU), a memory 404, e.g., random access memory (RAM) and/or read only memory (ROM), a module 405 for improving channel acquisition, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that an embodiment of the present invention can be implemented in software and/or in a combination of software and hardware, e.g., using application specific integrated circuits (ASIC), a general purpose computer or any other hardware equivalents. In one embodiment, the processes provided by the present module 405 for improving channel acquisition can be loaded into memory 404 and executed by processor 402 to implement the functions as discussed above. As such, the processes provided by the module 405 for improving channel acquisition times of the present invention can be stored on a computer readable medium, e.g., RAM memory, magnetic or optical drive or diskette and the like.

While the foregoing is directed to illustrative embodiments of the present invention, other and further embodiments of the invention may be devised without departing from the basic scope thereof, and the scope thereof is determined by the claims that follow.

What is claimed is:

1. A method for improving channel acquisition, comprising:
receiving at a router a data stream destined to one or more subscribers;
generating at said router at least one new access point in between two access points of said data stream; and
forwarding said at least one new access point upon detecting a request from a subscriber for receiving said data stream.

2. The method of claim 1, wherein said router is located at one or more levels within a hierarchy of routers within a network.

3. The method of claim 1, wherein said at least one new access point is generated at pre-determined intervals.

4. The method of claim 1, wherein said at least one new access point is generated on demand.

5. The method of claim 1, wherein a portion of said data stream beginning with an access point is temporarily stored at said router.

6. The method of claim 5, wherein said data stream is forwarded to said subscriber beginning with data immediately following said at least one new access point.

7. The method of claim 1, wherein said request comprises a request for a new channel.

8. The method of claim 1, wherein the access point comprises a reference frame.

9. A computer-readable medium having stored thereon a plurality of instructions, said plurality of instructions including instructions which, when executed by a processor, cause said processor to perform said steps of a method for improving channel acquisition, comprising:
receiving at a router a data stream destined to one or more subscribers;
generating at said router at least one new access point in between two access points of said data stream; and
forwarding said at least one new access point upon detecting a request from a subscriber for receiving said data stream.

10. The computer readable medium of claim 9, wherein said at least one new access point is generated at pre-determined intervals.

11. The computer readable medium of claim 9, wherein said at least one new access point is generated on demand.

12. The computer readable medium of claim 9, wherein a portion of said data stream beginning with an access point is temporarily stored at said router.

13. The computer readable medium of claim 9, wherein said request comprises a request for a new channel.

14. An apparatus for improving channel acquisition, comprising:
a processor;
a computer readable medium for receiving a data stream destined to one or more subscribers;
an encoder module for generating at least one new access point in between two access points of said data stream; and
an interface for forwarding said at least one new access point upon detecting a request from a subscriber for receiving said data stream.

15. The apparatus of claim 14, wherein said apparatus comprises a router located at one or more levels within a hierarchy of routers within a network.

16. The apparatus of claim 14, wherein said at least one new access point is generated at pre-determined intervals.

17. The apparatus of claim 14, wherein said at least one new access point is generated on demand.

18. The apparatus of claim 14, wherein a portion of said data stream beginning with a access point is temporarily stored in said computer readable medium.

19. The apparatus of claim 18, wherein said data stream is forwarded to said subscriber beginning with data immediately following said at least one new access point.

20. The apparatus of claim 14, wherein said request comprises a request for a new channel.
